(19) United States
(12) Patent Application Publication
(10) Pub. No.: US 2010/0181155 A1
(43) Pub. Date: Jul. 22, 2010

(54) DAMPING DEVICE AND FASTENING ARRANGEMENT

(75) Inventors: Hartmut Bohnet, Waldachtal (DE); Martin Linka, Horb a.N. (DE); Rainer Mallee, Waldachtal (DE); Hannes Spieth, Filderstadt (DE); Stefano Pampanin, Pavia (IT); Knut Maier, Eutingen (DE); Klaus Kaupp, Waldachtal (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: fischerwerke GmbH & Co. KG, Waldachtal (DE)

(21) Appl. No.: 12/664,468

(22) PCT Filed: Jul. 1, 2008
(86) PCT No.: PCT/EP08/05355

§ 371 Date: Dec. 14, 2009

(30) Foreign Application Priority Data
Jul. 11, 2007 (DE) 10 2007 032 313.3

(51) Int. Cl. F16F 7/12; F16F 1/36

(52) U.S. Cl. 188/371; 267/136

(57) ABSTRACT

The invention relates to a damping apparatus having a through-hole for an anchor (2) and having a damping element (11). In order to provide an improved damping apparatus (1) which can damp a wide spectrum of dynamic loads but which undergoes only insignificant deformation under working load, it is proposed that the damping apparatus (1) have a dissipation element (6) which, until a maximum relative force between the anchor (2) and a fastened article (12) fastened by the anchor (2) is exceeded, is elastically deformable and, after the maximum relative force has been exceeded, is elastically-plastically or plastically deformable.

The invention relates to a damping apparatus according to the preamble of patent claim 1 and also to a fastening apparatus having the preamble of patent claim 15.

Such a damping apparatus having a through-hole for an anchor is known from the publication DE 196 25 176 A1, the anchor serving for the fastening, to a wall, of an article to be fastened. The damping apparatus comprises a resilient element, which can damp shock-like jolts, which occur, for example, in the case of an earthquake, so that the anchor does not become excessively loaded. In that arrangement, with increasing deformation the force required for deformation of the resilient element becomes ever greater. A disadvantage of that arrangement lies in the fact that, by virtue of that behaviour of the resilient element, the fastened article can move significantly even when relatively small forces are applied to the fastened article. As a result, displacement of the fastened element relative to the wall can occur even in the event of low levels of loading.

A further damping apparatus is known from the publication WO 03/069096 A1. FIGS. 14 to 16 of that publication show a connection of two plates with a damping apparatus. The damping apparatus is formed in one of the plates by means of punching-out and comprises a punched hole arrangement with a radially extending web with a central hole for receiving an anchor. Under a working load, the web undergoes elastic deformation to begin with. If the working load is exceeded, however, for example owing to shock-like jolts due to an earthquake, plastic deformation of the web will come about, as result of which energy is dissipated and the jolt is damped. In that solution, it is disadvantageous that slight jolts under working load are not damped and damping comes about only by plastic deformation of the material. In addition, because of the simple structure, wherein one element is used both for damping and for energy dissipation, the damping apparatus can be designed only for a narrow, restricted spectrum of jolts.

The problem underlying the present invention is to provide a damping apparatus that is improved compared to the prior art and that can damp a wide spectrum of dynamic loads but undergoes only insignificant deformation under working load.

In accordance with the invention, the problem is solved by a damping apparatus having the features of claim 1 and by a damping-apparatus-comprising fastening arrangement having the features of claim 15. The damping apparatus according to the invention, having a through-hole for an anchor and having a damping element, has a dissipation element which, until a maximum relative force between the anchor and a fastened article fastened by the anchor is exceeded, is elastically deformable. In this context, a dissipation element is an element which converts kinetic energy into thermal energy as a result of an elastic, elastic-plastic or plastic deformation. After the maximum relative force has been exceeded, the dissipation element undergoes elastic-plastic or plastic deformation.

The damping apparatus is so constructed that the damping element and the dissipation element constitute spatially separate functional regions, as a result of which a clear assignment of the function of the dissipation element and of the damping element is possible. The damping apparatus can be constructed of one or more parts. It is feasible for the damping element and the dissipation element to act simultaneously and in parallel even under low loads. Also possible is an arrangement wherein solely the damping element or solely the dissipation element comes into action to begin with and only after a particular relative force between the anchor and a fastened article fastened by the anchor has been exceeded do both the damping element and the dissipation element come into action. As a result it is possible for the damping apparatus to be designed in optimum manner for the intended application. It is accordingly possible, for example, for the damping apparatus to be so designed that the dissipation element behaves in linearly elastic manner in the case of slight jolts and for the damping element to act in parallel thereto. The dissipation element undergoes only very slight deformation under a working load which is less than the maximum relative force. The working load is not a dynamic load but rather a static load, for example a transverse force applied to the anchor by a fastened article. If additional dynamic loads come into action, as a result of jolts or vibrations, the dissipation element can undergo elastic deformation so that it damps the dynamic loads together with the damping element. On the other hand, in the case of marked jolts where a high degree of energy dissipation is required, the dissipation element will undergo plastic deformation. As a result, load peaks having the consequence of overloading of the anchor are lessened by means of the damping apparatus. In this context, the term “anchor” is understood to be a fastening element such as, for example, a screw or a fixing plug, the damping apparatus being provided especially for the protection of fixing-plug-like fastening elements such as bolt and sleeve anchors, chemical fastening systems such as injection anchors and also frame fixing plugs made from plastics material.

A preferred embodiment of the damping apparatus according to the invention is so constructed that it acts as a spring damper element until the maximum relative force is exceeded. In this case, the dissipation element acts especially as a spring. In this context, a “spring” is to be understood as an element which is capable of elastic, especially linearly elastic, deformation. If the maximum relative force is not exceeded, the damping apparatus damps the dynamic loading in such a way that the damping apparatus is not damaged or lastingly deformed. Alternatively, the damping element could also not come into action until after the maximum relative force has been exceeded.

In a further embodiment of the damping apparatus according to the invention, there is provided at least one dissipation element which is arranged to undergo plastic deformation when a maximum relative force between the anchor and a fastened article fastened by the anchor is exceeded and, once the maximum relative force has been exceeded, to undergo plastic deformation even under the action of a relative force which in terms of magnitude is less than the maximum relative force. This ensures that, below the maximum relative force, that is to say in the range of the intended working load, a firm hold is maintained which prevents displacement of the fastened article. If, on the other hand, for example as a consequence of an earthquake, the maximum relative force is exceeded in shock-like manner, the energy of the shock and of any after-shocks can be absorbed by a plastic deformation. Such behaviour of the dissipation element is brought about in accordance with the invention as a result of the fact that an initial plastic deformation facilitates further deformation of the dissipation element. This behaviour is observed, for example, in the case of rod-shaped articles which are longitudinally compressed. After such articles have been bent once, they are easier to deform still further. In this context, “plastic deformation” is to be understood as also including the relative movement of two separate components of a broken dissipation element.

In a further preferred embodiment, a dissipation element is in the form of a radial dissipation element which extends radially between the through-hole and an outer surface and which is arranged to undergo plastic deformation when a maximum radial relative force between the anchor and a fastened article fastened by the anchor is exceeded and, once the maximum radial relative force has been exceeded, to undergo plastic deformation even under the action of a radial relative force which in terms of magnitude is less than the maximum relative force. As a result, the radial dissipation element is suitable for damping jolts which are directed parallel to the surface of the wall.

In a development of the preferred embodiment, a plurality of radially extending and curved dissipation elements are provided. This has the advantage that the individual radial dissipation elements can better undergo deformation without a radial dissipation element breaking as a result of an excessive mechanical stress, so that radially directed jolts can be damped repeatedly.

In another development of the preferred embodiment, the outer surface is in the form of an outer sleeve, and a wall of the through-hole is in the form of an inner sleeve. In addition to a simple structure, this means that the radial dissipation element or the radial damping elements are simultaneously longitudinally compressed and extended out so that a damping apparatus of such a kind can damp a multiplicity of vibrations in different directions.

In a further preferred embodiment, a dissipation element is in the form of an axially parallel dissipation element which extends parallel to the through-hole and which is arranged to undergo plastic deformation when a maximum axially parallel relative force between the anchor and a fastened article fastened by the anchor is exceeded and, once the maximum axially parallel relative force has been exceeded, to undergo plastic deformation even under the action of an axially parallel relative force which in terms of magnitude is less than the maximum axially parallel relative force. As a result, the axially parallel dissipation element is suitable for damping jolts which are directed perpendicular to the wall. The axially parallel dissipation element can, in addition, be so constructed that it also acts as a radial dissipation element.

In a development of the further preferred embodiment, the axially parallel dissipation element forms a ring whose axis of symmetry extends parallel to the through-hole, as a result of which there is obtained an extension, especially for a fastening by a central anchor.

In another development of the preferred embodiment, a plurality of axially parallel dissipation elements are provided. Compared to a single dissipation element, this has the advantage that the individual axially parallel dissipation elements can better undergo deformation without an axially dissipation element breaking as a result of an excessive mechanical stress, so that jolts that are directed axially parallel can be damped repeatedly.

In another development of the preferred embodiment, the plurality of axially parallel dissipation elements are connected to one another by means of a base ring. As a result, the individual dissipation elements mutually stabilise one another against radial forces.

In a further embodiment of the damping apparatus according to the invention, the dissipation element and the damping element are made from different plastics materials. Using different plastics materials it is possible to optimally adjust the different functional properties of the two elements. Special preference is given to the dissipation element or the damping element being made from a reinforced plastics material, especially a plastics material reinforced with fibres.

A further preferred embodiment of the damping apparatus according to the invention has a one-piece component having a first partial region which acts as dissipation element and having a second partial region which acts as damping element. Such a component can be produced, for example, in a two-component injection-moulding method, as a result of which simple and economical production is possible.

In a further preferred embodiment of the damping apparatus according to the invention, the dissipation element is a cup washer. Depending on the arrangement, the cup washer can be loaded radially or normally.

The damping apparatuses according to the invention are preferably used in a fastening arrangement according to the invention. In that case, the damping apparatus is arranged at least partially between the anchor and a fastened article so that forces are transferred from the fastened article, by way of the damping apparatus, to the anchor. The damping apparatus serves to damp out shock-like loads such as jolts, but also vibrations, without load peaks occurring that have the consequence of overloading of the anchor. The damping apparatus therein is so designed that the dissipation element can transfer the working load without significant deformation.

The invention is described in greater detail hereinbelow with reference to five exemplary embodiments.

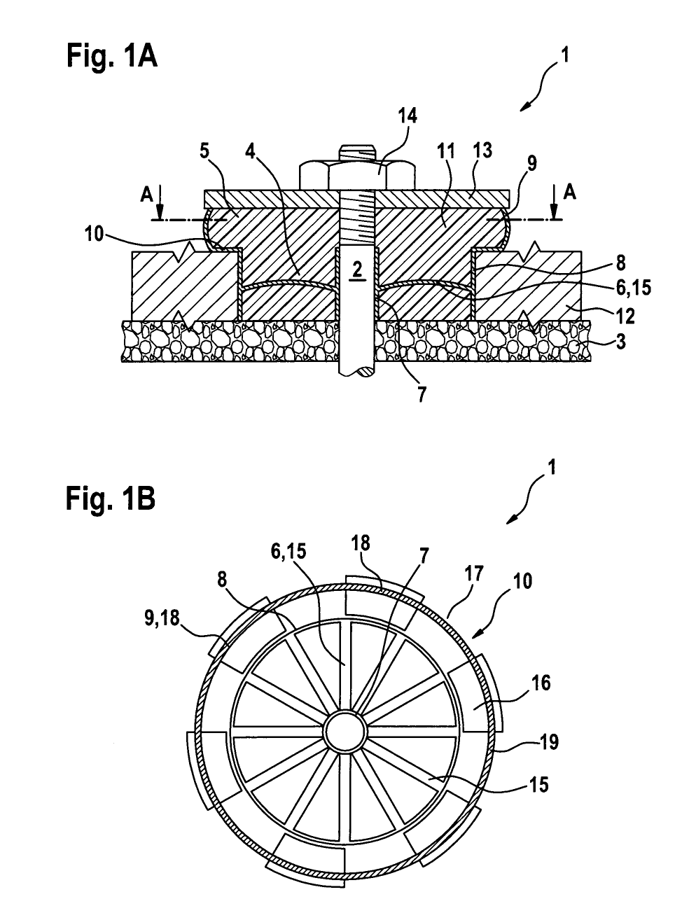

FIG. 1A is a sectional view of a damping apparatus according to a first embodiment;

FIG. 1B is a further sectional view of the damping apparatus according to the first embodiment;

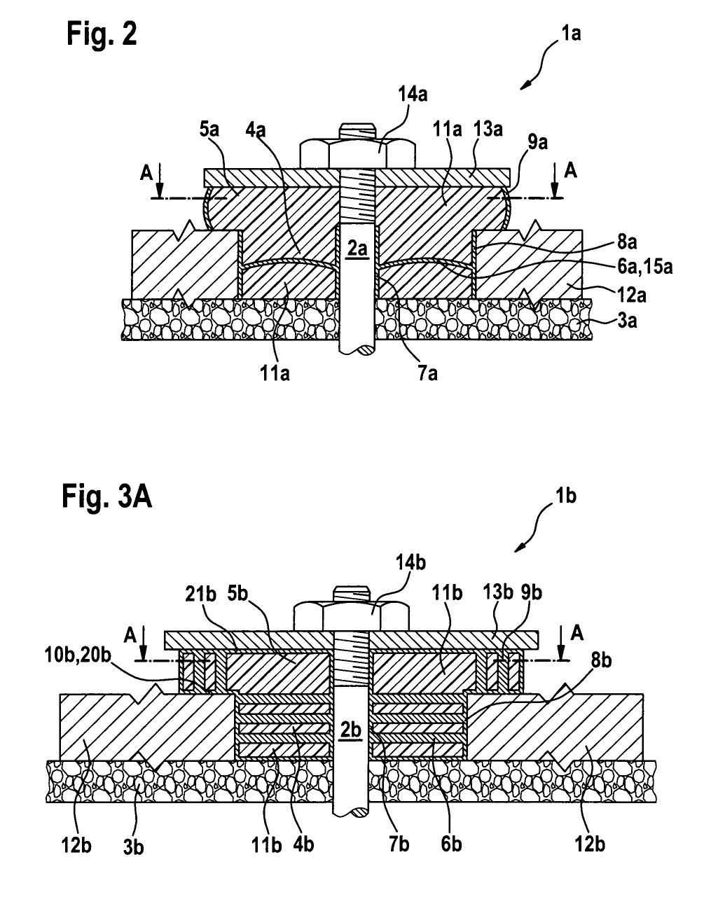

FIG. 2 is a sectional view of a damping apparatus according to a second embodiment;

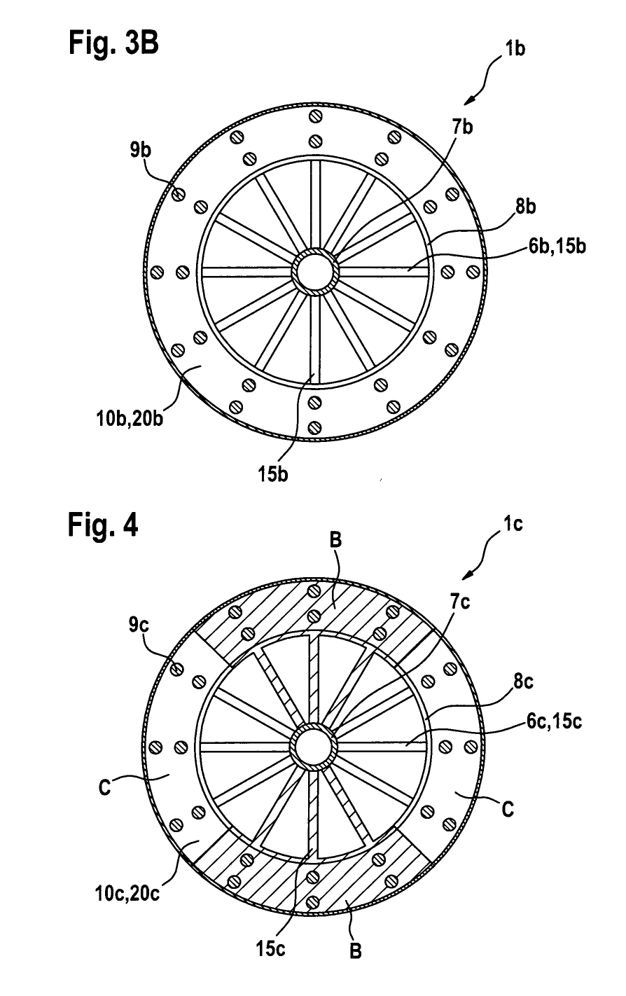

FIG. 3A is a sectional view of a damping apparatus according to a third embodiment;

FIG. 3B is a further sectional view of the damping apparatus according to the third embodiment;

FIG. 4 is a sectional view of a damping apparatus according to a fourth embodiment; and

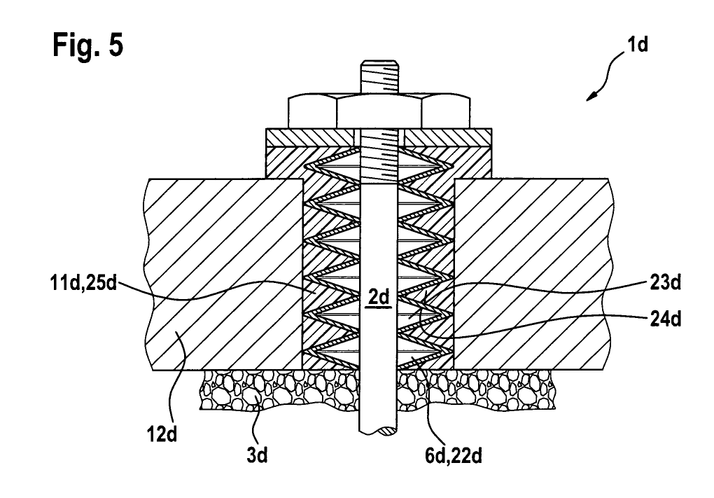

FIG. 5 is a sectional view of a damping apparatus according to a fifth embodiment.

FIG. 1A is a sectional view of a damping apparatus 1 according to a first embodiment, into which an anchor 2 has been inserted. The terms “radial” and “axially parallel” are used hereinbelow. These terms relate to the axis of the anchor 2, which has been inserted into the damping apparatus 1 and anchored in a wall 3. “Radial” therefore means perpendicular to the longitudinal axis of the anchor 2, or parallel to the wall 3, and “axially parallel” means parallel to the longitudinal axis of the anchor 2, or perpendicular to the wall 3. The damping apparatus 1 comprises a front portion 4 and a rear portion 5, the terms “front” and “rear” relating to the introduction direction of the anchor 2. In the front portion 4 there is provided a first, radial and curved dissipation element 6, which extends between an inner sleeve 7 and an outer sleeve 8. The connection points of the dissipation element 6 to the inner sleeve 7 and to the outer sleeve 8 are located in a radially extending plane. This relative position of both connection points is important to the buckling behaviour of the dissipation element 6. In the rear portion 5 there is provided a second, axially parallel and annular dissipation element 9, which is curved in the axial direction. The second dissipation element 9 is connected at its front edge to the rear edge of the outer sleeve 8 by way of an abutment portion 10. A front edge point and a rear edge point of the axially parallel dissipation element 9 are both located on an axially parallel line. This relative position of both edge points is important to the buckling behaviour of the dissipation element 9. The first, radial dissipation element 6, the inner sleeve 7, the outer sleeve 8, the second, axially parallel dissipation element 9 and the abutment portion 10 are produced as one piece from a material having a high modulus of elasticity (>40 kN/mm²), preferably metal and especially steel. The interior between the dissipation elements 6, 9 is filled with a damping element 11 such as, for example, a metal foam, a plastics material or a rubber material. The front region 4 of the damping apparatus 1 is accommodated in a cut-out formed in a fastened article 12. The abutment portion 10 abuts the fastened article 12. The fastened article 12 itself lies against the wall 3. A washer 13 abuts the rear portion 5 of the damping apparatus 1. The washer can also be fixedly connected to the damping apparatus 1. The anchor 2 is passed through the washer 13 and through a through-hole in the damping apparatus 1, which through-hole is partly surrounded by the inner sleeve 7, and is anchored in a hole in the wall 3. A nut 14 is screwed onto the anchor 2.

FIG. 1B is a further sectional view of the damping apparatus 1 according to the first embodiment along the line A-A of FIG. 1A without the damping material. The radial dissipation element 6 has a plurality of radially extending webs 15. Each of those webs 15 is capable on its own of dissipating energy. Apertures 16 are formed in the abutment portion 10 so that the latter can undergo deformation more readily. The second, axially parallel dissipation element 9 has a plurality of cut-outs 17 along its periphery. The second, axially parallel dissipation element 9 accordingly has dissipation portions 18, which are separated from one another by the cut-outs 17 but connected to one another by way of the abutment portion 10 and a base ring 19.

When a jolt causes a radial movement of the fastened article 12 relative to the wall 3, a web 15 and its neighbouring webs 15 are subjected to longitudinal compression, as a result of which they bend further, whereas a web 15 located opposite and its neighbouring webs 15 are extended out and, possibly, the outer sleeve 8 is bent inwards. The bending and deformation of the webs 15 and of the outer sleeve 8 is elastic to begin with and then, if a prespecified maximum relative force occurs, elastic-plastic or plastic, with the damping element 11 having a damping action. The original, pre-established bending of the webs 15 ensures that the longitudinally compressed webs 15 bend in a particular direction and, in addition, facilitate the bending itself. That original bending is not absolutely imperative. If a further jolt then causes a radial movement of the fastened article 12 relative to the wall 3 in the opposite direction, the webs 15 that previously were longitudinally compressed become extended out, whilst, at the same time, the webs 15 that were previously extended out become longitudinally compressed. This alternation can be repeated indefinitely in the case of elastic deformation of the webs 15. The jolts are further damped by the damping material 11. The damping element 11 also ensures that the fastening of the fastened article 12 is not damaged to the extent that it will come away if, for example, one or more webs 15 undergo(es) plastic deformation or is/are severed. If a jolt causes a relative movement of the fastened article 12 away from the wall 3, the second dissipation element 9 is longitudinally compressed, as a result of which the dissipation portions 18 are bent elastically to begin with and then, if a prespecified maximum relative force occurs, elastically-plastically or plastically. The dissipation portions 18 too can be straight, without a pre-established curvature.

For the embodiments that follow, identical reference numerals followed by a lower-case letter are used for functionally identical elements.

FIG. 2 is a sectional view of a damping apparatus 1 a according to a second embodiment. The front region 4a forms a front damping part and the rear region 5a forms a rear damping part. There is no abutment portion between the outer sleeve 8a and the axially parallel dissipation element 9a. Also, the damping element 11a in the rear region 5a and the damping element 11a in the front region 4a do not form one continuous piece. Consequently, the damping apparatus of FIG. 2 differs from the damping apparatus of FIGS. 1A and 1B in that it is formed of two parts. Optionally, more than two parts can also be provided. The two-part construction has the effect that deformation of the front region 4a and deformation of the rear region 5a are independent of one another. Because an abutment portion is not present, the first dissipation element 6a can undergo deformation more readily. Otherwise, the damping apparatus of FIG. 2 is identical to the damping apparatus of FIGS. 1A and 1B.

FIG. 3A is a sectional view of a damping apparatus 1b according to a third embodiment. The damping apparatus 1b comprises a front portion 4b and a rear portion 5b. In the front portion 4b there are provided a plurality of radial pin-shaped dissipation elements 6b, which extend in three rows between an inner sleeve 7b and an outer sleeve 8b. In the rear portion there are provided a plurality of axially parallel dissipation elements 9b, which extend between a front abutment surface 20b and a rear abutment surface 21b and which are arranged in two rings. The radial dissipation element 6b, the inner sleeve 7b, the outer sleeve 8b, the axially parallel dissipation elements 9b and the abutment portion 10b are produced as one piece, for example from a material having a high modulus of elasticity (>40 kN/mm²), preferably ceramic material. The interior of the damping apparatus 1b is filled with a damping element 11b, for example a metal foam or a rubber. Alternatively, it is feasible for the damping apparatus 1b to be made from plastics material, in which case the dissipation elements 6b, 9b and the damping element 11b are made from different plastics materials. The damping apparatus 1b can be produced as one piece, for example in a two-component injection-moulding method. Accordingly, for example, the dissipation elements 6b, 9b can be produced from a fibre-reinforced plastics material, as a result of which a high degree of strength and elasticity and a low degree of deformation of the dissipation elements under working load are achieved. However, a correspondingly high fibre proportion results in brittle behaviour of the plastics material, which runs counter to the desired behaviour of the damping apparatus in the event of plastic deformation.

FIG. 3B is a further sectional view of the damping apparatus 1b according to the third embodiment along the line A-A of FIG. 3A without the damping element 11b. The first, radial dissipation element 6b is arranged around the inner sleeve 7b. The webs 15b of the dissipation element 6b are made, for example, of ceramic material or fibre-reinforced plastics material and are suddenly severed if they are stressed by a jolt such that they undergo, after elastic deformation, a transition to elastic-plastic or purely plastic deformation. They do, however, fulfil their task of stably fastening the fastened article 12b to the wall 3b under working load, that is to say below a defined maximum relative force, which is transferred between the anchor 2b and the fastened article 12b by the damping apparatus 1b. The damping element 1b can completely or partly occupy the space between the anchor 2b and the fastened article 12b. The jolts are damped by the damping element 11b, but also by the dissipation element 6b.

The damping apparatus 1c shown in FIG. 4 differs from the damping apparatus 1b shown in FIG. 3B in that it is subdivided into segments B, C, which differ in terms of their damping behaviour. It is accordingly possible, depending on the direction of the loads being applied, to achieve optimum co-ordination between the dissipation elements 6c, 9c and the damping element 11c, with its being possible for the dissipation elements 6c, 9c and the damping element 11c in the individual segments B, C to differ from one another in their geometric characteristics and material. Subdivision into further segments is possible without departing from the concept of the invention.

FIG. 5 shows a further fastening apparatus 1d according to the invention, having a hole for an anchor 2d, which is anchored in a wall 3d. The damping apparatus 1d is located between the anchor 2d and a fastened article 12d and, together with these, forms a fastening arrangement. The fastening apparatus 1d has cup washers 22d as dissipation elements 6d. The cup washers 22d are so arranged that every two cup washers 22d lie opposite one another and are in contact with one another at their outwardly curved sides 23d or at their inwardly curved sides 24d. The intermediate space 25d between the outwardly curved sides 23d of the cup washers 22d is filled with a damping element 11d, for example of rubber or plastics material. Both the cup washers 22d and the damping element 11d are in contact with the fastened article 12d so that forces acting transversely to the axis of the anchor 2d are transferred by way of the cup washers 22d and the damping element 11d. The cup washers 22d are so selected that that they undergo only very slight deformation under working load. In the event of shock-like loading, for example caused by a jolt or by vibrations, the cup washers 22d undergo elastic deformation to begin with; if a maximum relative force between the anchor 2d and a fastened article 12d fastened by the anchor 2d is exceeded, they are then elastically-plastically or plastically deformable. The cup washers 22d and the damping element 11d act as a spring damper element. It is feasible that every two cup washers 22d are integrally connected with a segment of the damping element 11d so that the damping apparatus 1d is capable of having a modular structure. In that context, it is possible for the individual cup washers 22d and the individual segments of the damping element 11d to differ in their geometry and their material properties. As a result of combining different cup washers 22d and segments of the damping element 11d, optimum design of the damping apparatus 1d in terms of damping and deformation under working load is possible. Depending on the particular application, the cup washers 22d can be replaced by washers or other discs having a through-hole. It is not absolutely mandatory for the entire periphery of the damping apparatus 1d to be in contact with the fastened article 12d. LD

### LIST OF REFERENCE NUMERALS

### Damping Apparatus and Fastening Arrangement

1, 1a, 1b, 1c, 1d Damping apparatus

### 2, 2a, 2b, 2d Anchor

### 3, 3a, 3b, 3d Wall

4, 4a, 4b Front portion of the damping apparatus 1
5, 5a, 5b Rear portion of the damping apparatus 1
6, 6a, 6b, 6c, 6d First dissipation element
7, 7a, 7b, 7c Inner sleeve
8, 8a, 8b, 8c Outer sleeve
9, 9a, 9b, 9c Second dissipation element
10, 10b, 10c, 10d Abutment portion
11, 11a, 11b, 11d Damping element
12, 12a, 12b, 12c, 12d Fastened article

### 13, 13a, 13b Washer

### 14, 14a, 14b, 14d Nut

15, 15a, 15c Radially extending webs of the dissipation element 6
16 Aperture in the abutment portion 10

### 17 Cut-out

18 Dissipation portion
19 Base ring
20b Front abutment surface
21b Rear abutment surface
22d Cup washer
23d Outwardly curved side of cup washer 22d
24d Inwardly curved side of cup washer 22d
25d Intermediate space between the outwardly curved sides 23d

1. A damping apparatus having a through-hole for an anchor, having a damping element, wherein the damping apparatus has a dissipation element which, until a maximum relative force between the anchor and a fastened article fastened by the anchor is exceeded, is elastically deformable and, after the maximum relative force has been exceeded, is elastically-plastically or plastically deformable.

2. A damping apparatus according to claim 1, wherein the damping apparatus is so constructed that it acts as a spring damper element until the maximum relative force is exceeded.

3. A damping apparatus according to claim 1, wherein, once the maximum relative force has been exceeded, the dissipation element is plastically deformable even under the action of a relative force which in terms of magnitude is less than the maximum relative force.

4. A damping apparatus according to claim 1, wherein the damping apparatus is in the form of a radial damping apparatus which extends radially between the through-hole and an outer surface.

5. A damping apparatus according to claim 1, wherein the damping apparatus is in the form of an axially parallel damping apparatus which extends parallel to the through-hole.

6. A damping apparatus according to claim 1, wherein the dissipation element is curved.

7. A damping apparatus according to claim 1, wherein an axially parallel dissipation element is provided.

8. A damping apparatus according to claim 1, wherein the outer surface of the damping apparatus is in the form of an outer sleeve; and in that wall of the through-hole is in the form of an outer sleeve of an inner sleeve.

9. A damping apparatus according to claim 1, wherein the axially parallel dissipation element forms a ring whose axis of symmetry extends parallel to the through-hole.

10. A damping apparatus according to claim 1, wherein the damping apparatus has a plurality of axially parallel dissipation elements which are connected to one another by means of a base ring.

11. A damping apparatus according to claim 1, wherein the dissipation element and the damping element are made from different plastics materials.

12. A damping apparatus according to claim 1, wherein the dissipation element or the damping element is made from a reinforced plastics material, especially a plastics material reinforced with fibres.

13. A damping apparatus according to claim 1, wherein the damping apparatus has a one-piece component having a first partial region which acts as dissipation element and having a second partial region which acts as damping element.

14. A damping apparatus according to claim 1, wherein the dissipation element is a cup washer.

15. A fastening arrangement having a damping apparatus according to claim 1 and having an anchor, wherein the damping device is arranged at least partially between the anchor and a fastened article.
